(19) United States
(12) Patent Application Publication
(10) Pub. No.: US 2026/0220280 A1
(43) Pub. Date: Jul. 30, 2026

(54) SYSTEMS AND METHODS FOR CATALOGING SECURED DATA IN ENCRYPTED CLUSTERS BASED ON RECEIVED AUTHORIZATIONS

(71) Applicant: Capital One Services, LLC, McLean, VA (US)

(72) Inventors: Jude Anasta, Hudson, NY (US); Andrew Oestreicher, Washington, DC (US); Damian Von Schoenborn, St. Paul, MN (US); Kemar Thomas, Severn, MD (US)

(73) Assignee: Capital One Services, LLC, McLean, VA (US)

(21) Appl. No.: 19/040,844

(22) Filed: Jan. 29, 2025

(51) Int. Cl. G06F 21/60; G06F 16/28; G06N 20/00; H04L 9/32

(52) U.S. Cl. CPC G06F 21/602; G06F 16/285; G06N 20/00; H04L 9/32

(57) ABSTRACT

Systems and methods for cataloging secured data in encrypted clusters based on received authorizations are described. For example, the system may retrieve dataset, wherein the dataset comprises non-native data, wherein the dataset has a first data cluster corresponding to a first approved-use authorization applied to a first non-native data source used to populate the first data cluster, and wherein the dataset has a second data cluster corresponding to a second approved-use authorization applied to a second non-native data source used to populate the first data cluster.

### BACKGROUND

Artificial Intelligence (“AI”) models often struggle to perform effectively in data-sparse environments due to their reliance on large amounts of high-quality data for training and validation. These models, particularly deep learning systems, are designed to recognize patterns and make predictions based on statistical regularities found in datasets. When data is scarce, the models lack sufficient examples to learn these patterns, leading to poor generalization and unreliable predictions. Furthermore, limited data can exacerbate issues like overfitting, where the model memorizes the few examples it has seen rather than learning underlying principles that can be applied more broadly. The absence of diverse and representative data also makes it challenging to account for variability or edge cases, which are critical for robust performance. Additionally, data sparsity can hinder fine-tuning or transfer learning approaches, as there may not be enough contextual information to adapt pre-trained models effectively to the specific task or domain. As a result, creating reliable AI solutions for data-sparse environments often requires innovative techniques, such as synthetic data generation, domain-specific modeling, or incorporating expert knowledge into the system.

Creating new data, such as synthetic data, or collecting data from non-native sources introduces additional technical challenges in data-sparse environments because these methods often compromise the authenticity, relevance, and diversity of the dataset. Synthetic data, while helpful in supplementing limited datasets, may not fully capture the complexity, noise, or variability of real-world phenomena, potentially leading to models that perform well on synthetic examples but poorly on real-world tasks. Similarly, data collected from non-native sources may not align with the specific characteristics of the target domain, introducing biases or inconsistencies that can distort the model's understanding of the problem. These datasets may also fail to represent the contextual nuances, cultural factors, or environmental conditions unique to the native data, reducing their applicability. Furthermore, the integration of such data requires careful preprocessing, validation, and adaptation, which can be resource-intensive and prone to errors. If not managed properly, these issues can propagate through the modeling process, undermining the reliability and accuracy of AI systems in data-sparse environments.

Using synthetic or non-native data in data-sparse environments becomes particularly problematic when dealing with sensitive information such as Personally Identifiable Information (PII) due to the heightened risks of privacy breaches, regulatory non-compliance, and ethical concerns. Synthetic data generation often relies on real PII to model realistic datasets, creating a risk that identifiable patterns or attributes could inadvertently persist in the synthetic version, potentially exposing individuals to privacy violations. Similarly, collecting data from non-native sources may introduce datasets that lack adequate anonymization or fail to meet the stringent data protection standards required by regulations. These challenges are compounded by the need to ensure that such data remains representative and secure while avoiding biases that could arise from improper handling or mismatched contexts. Additionally, the technical complexity of safeguarding sensitive data during its transformation or integration adds another layer of difficulty, as errors in this process could lead to unintended data leakage or misuse. In sensitive contexts, these issues not only jeopardize trust and compliance but also raise significant ethical dilemmas, making the use of synthetic or non-native data a critical challenge.

### SUMMARY

Systems and methods are described herein for novel uses and/or improvements to the collection and cataloguing of training data. Specifically, as opposed to collecting data from multiple sources and applying a universal security and encryption process across the data, the systems and methods describe a security and encryption process that is individually applied to data clusters having similar authorization. As one example, methods and systems are described herein for securely cataloging data in data sparse environments using encrypted clusters based on received security authorizations specific to an encrypted clustering process. For example, by applying security and encryption processes individually to data clusters with similar authorizations, the system provides a technical improvement over a universal approach by enabling more granular control, reducing risk, and/or enhancing operational efficiency. By tailoring the security measures to the specific sensitivity and access requirements of each cluster, the system ensures that the most stringent protections are applied where needed without overburdening less critical data. By isolating data clusters, the impact of a potential breach is contained, as attackers would need to circumvent multiple, independently managed security layers rather than a single universal system.

Additionally, by tailoring the security of each data cluster based on similar authorizations, the system may more easily determine what data may be used for different purposes, applications, and/or within one or more approved uses. For example, when data clusters are organized and secured according to authorization levels, usage permissions, and specific characteristics, it becomes simpler to track and enforce policies about how that data may be accessed and utilized. For instance, data tagged for a specific purpose, such as research, marketing, or operational analysis, can be easily identified and segregated from other clusters, preventing misuse or unintentional cross-purpose applications. This structured approach also enables systems to dynamically evaluate data against usage criteria, ensuring compliance with legal, ethical, and organizational guidelines. Moreover, such granular control simplifies governance, as policies can be applied at the cluster level, reducing the complexity of managing permissions and ensuring data remains within its approved scope. By aligning security with intended use, tailored clustering enhances transparency, accountability, and flexibility in managing diverse datasets.

In some aspects, systems and methods for cataloging secured data in encrypted clusters based on received authorizations are described. For example, the system may retrieve a first dataset, wherein the first dataset comprises native data. The system may retrieve a second dataset, wherein the second dataset comprises non-native data, wherein the second dataset has a first data cluster corresponding to a first approved-use authorization applied to a first non-native data source used to populate the first data cluster, and wherein the second dataset has a second data cluster corresponding to a second approved-use authorization applied to a second non-native data source used to populate the first data cluster. The system may receive a system request for training data for a first model, wherein the system request has a first request characteristic. The system may, in response to the system request, activate a data retrieval workflow, wherein the data retrieval workflow: accesses the native data from the first dataset; determines a data sufficiency of the native data; and in response to determining that the native data is insufficient, accesses the non-native data from the second dataset, wherein accessing the non-native data comprises comparing the system request to a first data cluster characteristic corresponding to the first data cluster. The system may generate the training data based on the data retrieval workflow.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for receiving approved-use authorizations for non-native data source, in accordance with one or more embodiments.

FIG. 2 shows an illustrative diagram for clustering data on a user into a first dataset and a second dataset, in accordance with one or more embodiments.

FIG. 3 shows illustrative components for a system used to train a model, in accordance with one or more embodiments.

FIG. 4 shows a flowchart of the steps involved in cataloging secured data in encrypted clusters based on received authorizations, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

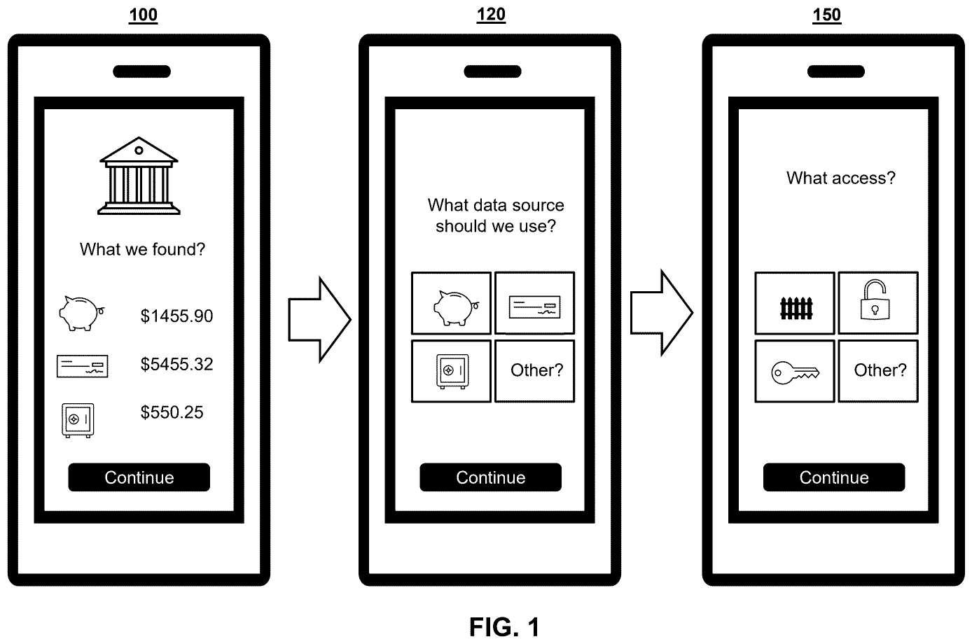

FIG. 1 shows an illustrative diagram for receiving approved-use authorizations for non-native data source, in accordance with one or more embodiments. For example, FIG. 1 shows user interface 100, user interface 120, and user interface 150. As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include information about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be digital representation of a person's identity. The data in the user profile may be generated based on the system actively or passively monitoring the user.

The system may receive a first user input indicating potential non-native data sources through an interactive platform, such as user interface 100, that allows users to specify or identify data sources. This interface may be designed with user-friendly elements like text fields, dropdown menus, checkboxes, or searchable lists where users can input details about potential sources. For example, user interface 100 might prompt users to provide information such as the name of the organization, the type of database or service (e.g., cloud storage, CRM system, or third-party application), and metadata describing the nature of the data (e.g., demographics, transaction records, or behavioral metrics). To assist users, the system may also offer pre-populated suggestions based on integrations, known repositories, or patterns identified in existing configurations. Users might also upload relevant documentation, such as API keys or connection credentials, to validate and describe the non-native sources. Once the input is submitted, the system processes and catalogs these potential sources for further evaluation and integration steps. This structured input mechanism ensures clarity, scalability, and ease of managing diverse data sources.

The system may receive a second user input indicating a specific non-native data source to receive user data from through a dedicated platform like user interface 120, which facilitates selection from previously identified options. User interface 120 may display a curated list or visual representation of potential data sources, often enhanced with metadata about each source, such as its name, type, origin, and relevance to the user's needs. Users can interact with the interface by selecting a data source directly—via checkboxes, radio buttons, or dropdown menus—or by refining their choices using search filters, sorting options, or categorization tools. To ensure precision, the interface may also provide additional details about each source, such as the data types available, access protocols, or integration requirements, enabling users to make informed decisions. After selecting a source, the system may prompt users to confirm their choice or input supplementary details, such as credentials or API configurations, to initiate the connection. This process streamlines data source identification and ensures accurate integration with the system's data management framework.

The system may receive a third user input indicating access and approved uses for data from the non-native source through a specialized interface, such as user interface 150, which allows users to define permissions and usage policies. User interface 150 may present configurable options for specifying who can access the data, under what conditions, and for what purposes. Users might interact with dropdown menus, checkboxes, or text fields to assign access roles (e.g., admin, analyst, or read-only user), specify approved applications or workflows, and set constraints on data usage (e.g., research-only, marketing, or compliance purposes). User interface 150 may also enable users to set parameters like data retention periods, geographic restrictions, or anonymization requirements to align with regulatory or organizational policies. To simplify the process, the system could provide templates for common use cases or real-time validation checks to ensure the input aligns with applicable rules. Once submitted, the input is processed to generate enforcement rules or policies that govern how the non-native data is accessed and utilized within the system, ensuring compliance and security while supporting operational needs.

The system may receive a user request to generate a first recommendation, wherein the first recommendation is based on non-public and secured data. For example, the system may receive a user request to generate a first recommendation based on non-public and secured data through an interactive user interface or API where the user specifies their query or desired outcome. This interface might include a search bar, dropdown menus, or forms that allow the user to input parameters or criteria for the recommendation, such as specific data categories, target outcomes, or contextual constraints. The system verifies the user's credentials and access permissions before processing the request to ensure compliance with security and privacy protocols. For example, the user may be required to log in using secure authentication methods, such as multi-factor authentication, or provide explicit authorization tokens that confirm their eligibility to access the non-public data. Once the request is authenticated, the system processes the user's inputs in conjunction with secured data stored in encrypted or access-controlled environments. Advanced filtering or machine learning algorithms are then applied to analyze the data and generate the first recommendation. Finally, the system delivers the result in a secure and user-friendly format, ensuring that non-public data remains protected throughout the process.

In some embodiments, non-public and secured data may refer to information that is not publicly accessible and is protected through security measures to ensure confidentiality, integrity, and controlled access. This type of data is typically sensitive in nature, requiring safeguards to prevent unauthorized access or misuse. Examples may include Personally Identifiable Information (PII) such as names, social security numbers, or email addresses; financial data like bank account details or credit card information; health records governed by regulations such as HIPAA; and proprietary business data, such as trade secrets, intellectual property, or confidential communications. Non-public data also includes information classified for security purposes, like government or military intelligence, and internal organizational data, such as employee records or performance analytics. Secured data is often stored in encrypted formats, housed within firewalled systems, or accessed via permission-based protocols, ensuring its availability only to authorized users or applications in accordance with regulatory or organizational policies.

In some embodiments, the native data may comprise secured data for a first user received via a native data collection process. For example, the system may receive native data comprising secured data for a first user through a native data collection process, which involves directly gathering information from the user or the system's integrated sources within its own controlled environment. A native data collection process may include mechanisms such as user-submitted forms, in-app interactions, sensor inputs, or transactions conducted through the system's proprietary platform. For example, a user might fill out a secure form on the system's website, or a wearable device might transmit health metrics directly to the system's servers. This process ensures that the data is collected in a format and under conditions that align with the system's predefined security, privacy, and compliance protocols.

In contrast, non-native data may refer to information that originates outside the system's direct control, often from third-party or external sources, and is integrated into the system via external APIs, file uploads, or data-sharing agreements. A non-native data collection process may involve importing data that was not generated or collected by the system itself, such as acquiring customer information from a partner organization or purchasing anonymized datasets from a data provider.

In some embodiments, native data may be collected directly within the system's environment, giving it full oversight of the data collection process, while non-native data comes from external sources, requiring additional measures for integration, validation, and security to ensure it meets the system's standards. Native data processes inherently offer greater reliability, traceability, and alignment with the system's requirements, whereas non-native processes introduce potential challenges related to compatibility, security, and data governance.

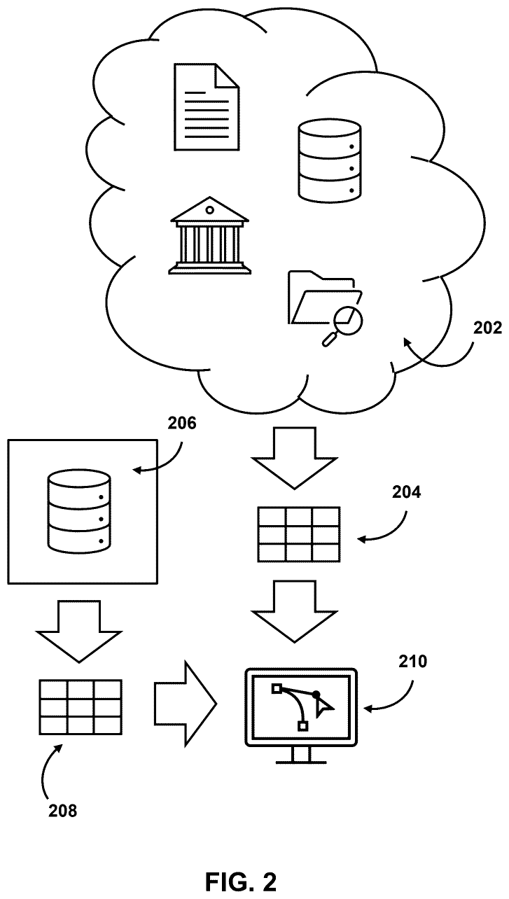

FIG. 2 shows an illustrative diagram for clustering data on a user into a first dataset and a second dataset, in accordance with one or more embodiments. For example, FIG. 2 shows system 200. System 200 may receive both native and non-native data. Native data may be received from native data source 206, while non-native data may be received from one or more of a plurality of non-native data sources 202. For example, a system, such as system 200, can receive both native and non-native data and utilize it as needed for a model, such as model 210, by employing distinct data pipelines tailored to each data source. Native data, collected directly through controlled processes within the system's environment, is received from a native data source (e.g., native data source 206). This data is immediately recorded in a designated dataset (e.g., dataset 208), ensuring it is stored securely and aligned with the system's predefined format and governance standards. Simultaneously, the system can integrate non-native data from one or more external sources (e.g., non-native data sources 202). This data is validated, transformed, and recorded separately in another dataset (e.g., dataset 204) to maintain a clear distinction between native and non-native information.

System 200 may record native data in dataset 208, while non-native data is recorded in dataset 204. System 200 may then use data from dataset 204 and dataset 208 as needed for model 210. For example, system 200 can then leverage both datasets for various applications, such as training, validating, or deploying model 210. For instance, the system might combine native and non-native data to improve the model's robustness by increasing its diversity or tailoring it to specific use cases. The use of separate datasets ensures traceability and simplifies compliance with data usage policies, as each dataset can be handled according to its source and associated security requirements. By integrating and processing data from both sources, the system achieves a comprehensive, flexible approach to model optimization while maintaining data integrity and security.

System 200 may clustering data on a user into a first dataset and a second dataset, wherein the first dataset comprises native data, wherein the second dataset comprises non-native data, wherein the second dataset has a first data cluster corresponding to a first approved-use authorization applied to a first non-native data source used to populate the first data cluster, and wherein the second dataset has a second data cluster corresponding to a second approved-use authorization applied to a second non-native data source used to populate the first data cluster.

A system, such as system 200, clusters data on a user into a first dataset and a second dataset by applying approved-use authorizations to ensure that data is organized and governed according to its intended purpose and compliance requirements. Native data, directly collected by the system, is grouped into the first dataset (e.g., dataset 208), which is governed by the system's internal security and usage policies. Non-native data, originating from external sources, is organized into the second dataset (e.g., dataset 204) based on approved-use authorizations specific to each data source.

Within the second dataset, the system further divides the data into clusters corresponding to the distinct approved-use authorizations associated with the respective non-native data sources. For example, the system might create a first data cluster within the second dataset that includes data from a first non-native source, governed by a specific authorization permitting its use for analytics purposes. Simultaneously, it may form a second data cluster that includes data from a second non-native source, restricted to use in research activities under a separate authorization. Each cluster is tagged or annotated with metadata describing its source, the applicable authorizations, and any usage constraints, ensuring clarity and enforceability of data governance policies.

This clustering process allows the system to manage and use data in a way that respects the approved-use limitations while enabling flexible integration into workflows, such as feeding the clusters into a model like model 210. By maintaining clear boundaries between data clusters and datasets, system 200 ensures compliance, enhances data security, and simplifies auditing and monitoring of data usage.

Clustering data based on approved-use authorizations involves several systematic processes designed to ensure accurate grouping, compliance, and usability. The first step is data collection and preprocessing, where the system gathers data from both native and non-native sources, ensuring that metadata such as origin, type, and associated permissions are recorded. The collected data is then cleaned and normalized by removing duplicates, addressing missing values, and standardizing formats to ensure consistency across sources. Each data point is annotated with metadata, including its source, sensitivity, approved-use authorizations, and other relevant details.

The next step is authorization analysis, where the system maps the approved-use authorizations to specific rules or constraints, such as data usage for analytics, research, or marketing. These policies are translated into machine-readable rules to enable automated clustering. The system then performs feature extraction, identifying key attributes from the data—such as source identifiers and access permissions—that are relevant for the clustering process.

Once preprocessing and authorization analysis are complete, the system applies clustering algorithms to group the data. Rule-based clustering uses explicit rules derived from authorizations to assign data to clusters, ensuring compliance with usage restrictions. For more complex scenarios, algorithmic clustering methods, such as k-means, hierarchical clustering, or density-based clustering, can identify patterns in the data while respecting authorization boundaries. In cases with clearly delineated boundaries, data may be directly assigned to predefined clusters without the need for advanced algorithms.

After clustering, the system performs validation and compliance checks to ensure each data point is correctly placed according to its approved-use authorization. Any conflicts, such as a data point qualifying for multiple clusters with differing authorizations, are identified and resolved. The system then organizes the clusters by storing them in separate logical units, such as partitions or tables within datasets (e.g., dataset 204 and dataset 208), and integrates access control mechanisms to ensure only authorized users or processes can access each cluster. An audit trail is created to document the clustering process, providing transparency and supporting compliance.

Finally, the system implements ongoing monitoring and re-clustering processes to adapt to changes. If data governance policies or authorizations are updated, or if new data is added or modified, the system re-clusters the data as necessary to maintain compliance and operational integrity. By following these steps, the system ensures that data is grouped accurately, securely, and in a manner that respects approved-use authorizations, enabling efficient and compliant usage in downstream applications.

In some embodiments, system 200 may securely catalog data in data-sparse environments by utilizing encrypted clusters that are created and managed based on received security authorizations specific to an encrypted clustering process. The process begins by collecting data from various sources, both native and non-native, and annotating it with metadata, including details such as its origin, sensitivity, and associated security authorizations. These authorizations define the encryption requirements and access controls for each data segment, ensuring compliance with privacy and security policies.

Using these security authorizations, the system segments the data into clusters, grouping data points that share similar security and access requirements. Each cluster is then encrypted using cryptographic algorithms tailored to its sensitivity level and authorization criteria. For example, highly sensitive data may be encrypted using advanced encryption standards (e.g., AES-256) and stored in isolated, access-controlled environments, while less sensitive clusters might use lighter encryption methods optimized for performance.

The encrypted clusters are cataloged in a structured data repository, where each cluster is tagged with metadata describing its encryption level, access permissions, and approved usage contexts. This cataloging process ensures that data remains traceable and that its security measures are transparent and enforceable. The system also implements secure key management to control access to the encrypted clusters, ensuring that only authorized users or processes can decrypt and access the data.

To maintain security in data-sparse environments, the system monitors and updates the encrypted clustering process dynamically. If new data is added or security authorizations change, the system re-evaluates the clustering structure, applying updated encryption and access controls as necessary. By securely cataloging data in this manner, the system ensures that even in data-sparse contexts, information remains protected, compliant with regulations, and readily accessible for authorized use.

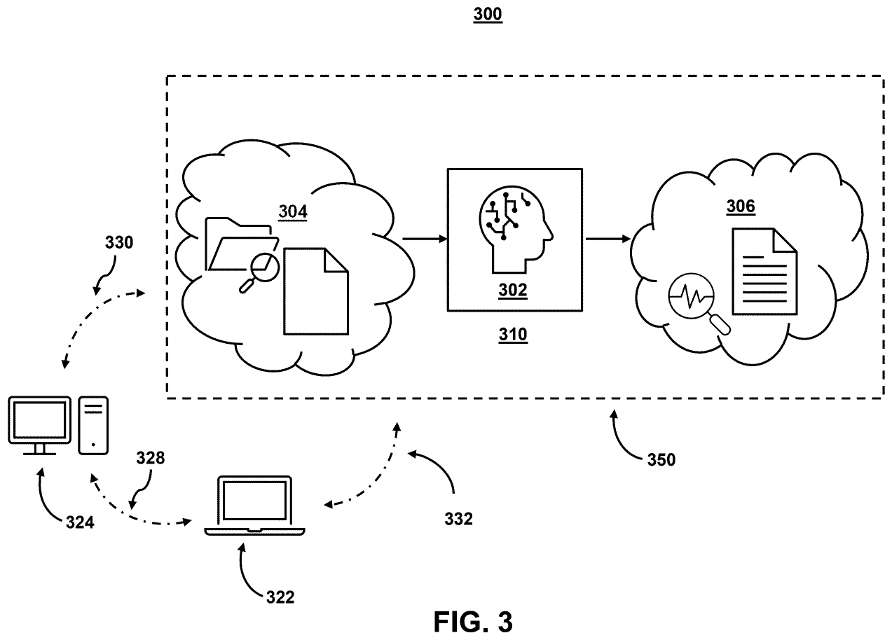

FIG. 3 shows illustrative components for a system used to train a model, in accordance with one or more embodiments. For example, FIG. 3 may show illustrative components for securely cataloging data in data sparse environments using encrypted clusters based on received security authorizations specific to an encrypted clustering process. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The output of the model (e.g., model 302) may be used to catalog secured data in encrypted clusters based on received authorizations.

In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

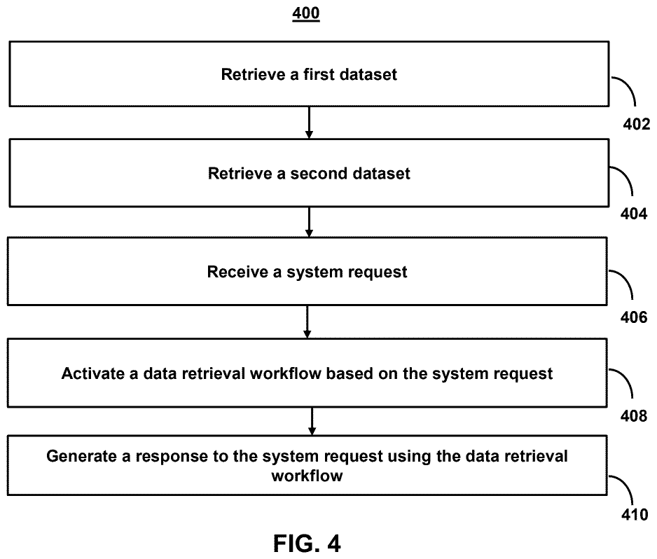

FIG. 4 shows a flowchart of the steps involved in cataloging secured data in encrypted clusters based on received authorizations, in accordance with one or more embodiments. For example, the system may use process 400 (e.g., as implemented on one or more system components described above) in order to securely cataloging data in data sparse environments using encrypted clusters based on received security authorizations specific to an encrypted clustering process.

At step 402, process 400 (e.g., using one or more components described above) retrieve a first dataset. For example, the system may retrieve a first dataset, wherein the first dataset comprises native data. For example, the system may retrieve a first dataset comprising native data by leveraging its internal data management infrastructure and predefined access protocols. Native data, which is collected directly through the system's own processes, is typically stored in a secure, centralized repository, such as a database or data warehouse, designed to organize and manage this data efficiently. The retrieval process begins when the system receives a query or request, either from a user or an application, specifying the data needed. This request might include criteria such as data type, time range, or other filtering parameters. Once the request is received, the system authenticates the user or application making the request to ensure they have the necessary permissions to access the dataset. This authentication process may involve verifying credentials, checking role-based access controls, or validating the request against security and compliance policies. After successful authentication, the system locates the requested native data within its repository by using indexing, metadata tags, or structured query languages (e.g., SQL). The system then retrieves the relevant data, applies any necessary transformations (such as filtering, aggregation, or formatting), and delivers it in the requested format. Throughout the retrieval process, the system ensures that data integrity and confidentiality are maintained by utilizing secure transfer protocols (e.g., HTTPS) and, if needed, encryption for data in transit. This systematic approach enables the secure and efficient retrieval of native data for authorized use cases, such as analysis, reporting, or integration into downstream workflows.

At step 404, process 400 (e.g., using one or more components described above) retrieve a second dataset. For example, the system may retrieve a second dataset, wherein the second dataset comprises non-native data, wherein the second dataset has a first data cluster corresponding to a first approved-use authorization applied to a first non-native data source used to populate the first data cluster, and wherein the second dataset has a second data cluster corresponding to a second approved-use authorization applied to a second non-native data source used to populate the first data cluster.

In some embodiments, the system may retrieve a second dataset comprising non-native data, including distinct clusters governed by separate approved-use authorizations, through a structured and secure process. Non-native data, originating from external sources, is stored in the system within a second dataset, organized into clusters based on the associated approved-use authorizations. Each cluster is annotated with metadata specifying its source, usage constraints, and access permissions, ensuring clear boundaries between clusters. The retrieval process begins with a query or request that specifies the desired data and its intended use. The system first authenticates the user or application making the request, verifying their credentials and ensuring their access permissions align with the approved-use authorizations for the requested data. Once authenticated, the system evaluates the request against the metadata of the dataset's clusters to identify which clusters can be accessed under the specified authorization. If the query pertains to the first data cluster, the system retrieves data specifically from that cluster, which corresponds to the first approved-use authorization and is populated from the first non-native data source. Similarly, if the request includes data from the second cluster, the system retrieves it from the cluster governed by the second approved-use authorization and populated by the second non-native data source. The system applies any necessary transformations, such as filtering or aggregation, to tailor the data to the user's needs while maintaining compliance with usage constraints. Throughout the retrieval process, the system ensures data security and integrity by using secure communication protocols (e.g., HTTPS) and encryption for data in transit. Additionally, access logs and audit trails are maintained to document the retrieval activity, supporting transparency and regulatory compliance. By adhering to these structured steps, the system ensures that non-native data is retrieved securely, accurately, and in alignment with its approved-use authorizations.

In some embodiments, the system may retrieve the second dataset by receiving a first user authorization to aggregate data from the first non-native data source, receiving a second user authorization to aggregate data from the second non-native data source, in response to the first user authorization, populating the second dataset based on the first non-native data source, and, in response to the second user authorization, populating the second dataset based on the second non-native data source. For example, the system may system retrieves the second dataset by following a structured process that involves receiving user authorizations and aggregating data from specified non-native sources based on those authorizations. Initially, the system receives a first user authorization that grants permission to access and aggregate data from a first non-native data source. This authorization specifies the scope of access, the intended use of the data, and any applicable constraints, such as data sensitivity or regulatory requirements. In response to this authorization, the system connects to the first non-native data source, retrieves the approved data, and processes it for inclusion in the second dataset. This processing may involve filtering, cleaning, or transforming the data to align it with the system's data storage and usage standards. Subsequently, the system receives a second user authorization that permits access to data from a second non-native data source. Similar to the first authorization, this second authorization defines the terms under which the data may be accessed and used. Upon receiving this second authorization, the system establishes a connection with the second non-native data source, retrieves the data in accordance with the specified permissions, and processes it for inclusion in the second dataset. During this step, the system ensures that data from the second source is properly integrated with the data already aggregated from the first source, maintaining consistency and coherence within the second dataset. Throughout this process, the system enforces security measures, such as authentication, encryption, and access controls, to protect the data during aggregation and integration. Metadata is recorded for both data sources, including details about the user authorizations, data provenance, and any preprocessing steps applied. This metadata ensures traceability and compliance with governance policies. By sequentially aggregating data from the first and second non-native sources based on user authorizations, the system effectively populates the second dataset, enabling its use for analysis, modeling, or other approved purposes.

In some embodiments, the system may retrieve the second dataset by receiving, from a first user, a first approved-use for the first non-native data source, selecting the first data cluster, from a plurality of data clusters, based on the first approved-use, receiving, from the first user, a second approved-use for the second non-native data source, and selecting the second data cluster, from the plurality of data clusters, based on the second approved-use. For example, the system retrieves the second dataset by leveraging user-specified approved-uses to identify and select appropriate data clusters from a plurality of clusters within the dataset. First, the system receives input from a first user indicating a first approved-use for data originating from a first non-native data source. This approved-use specifies the context or purpose for which the data is authorized, such as analytics, research, or compliance-related applications. Based on this input, the system evaluates the metadata and characteristics of the plurality of data clusters in the second dataset, identifying the cluster that aligns with the first approved-use and corresponds to the first non-native data source. This cluster is selected for inclusion in the data retrieval process. Subsequently, the system receives a second input from the first user indicating a second approved-use for data originating from a second non-native data source. Similar to the first approved-use, this input defines the specific usage constraints or purposes authorized for this data. The system again evaluates the metadata and characteristics of the available data clusters, selecting the second cluster that matches the second approved-use and is populated by data from the second non-native data source. This ensures that the retrieved data respects the intended purpose and any applicable governance rules. During this process, the system enforces strict access controls, verifying that the first user has the necessary permissions to specify approved-uses and retrieve data clusters. Each selected cluster is processed as needed—such as being filtered, transformed, or aggregated—to prepare it for the intended use. Metadata documenting the approved-uses, user inputs, and cluster selection is recorded to ensure traceability and compliance with data policies. By dynamically selecting data clusters based on user-defined approved-uses, the system effectively retrieves the second dataset while maintaining alignment with usage constraints and regulatory requirements.

In some embodiments, the system may retrieve the second dataset by receiving, from a first user, first consent in a first consent format for the first non-native data source, selecting the first data cluster, from a plurality of data clusters, based on the first consent format, receiving, from the first user, second consent in a second consent format for the second non-native data source, and selecting the second data cluster, from the plurality of data clusters, based on the second consent format. For example, the system may retrieve the second dataset by incorporating user-provided consent in different formats to guide the selection of appropriate data clusters from a plurality of clusters. Initially, the system receives, from a first user, a first consent associated with a first non-native data source. This consent, provided in a specific format (e.g., a signed document, an electronic agreement, or a consent token), outlines the permissions granted for accessing and using the data from the first non-native source. The system interprets the first consent format to extract the relevant terms, such as the approved purposes, access limitations, and duration of validity. Using this information, the system evaluates the metadata and characteristics of the data clusters within the second dataset, identifying the cluster corresponding to the first non-native data source and aligned with the terms specified in the first consent. The system then selects this cluster for inclusion in the second dataset retrieval process. Subsequently, the system receives a second consent from the first user, related to a second non-native data source. This second consent is provided in a different format (e.g., a verbal agreement transcript, a digital signature, or a structured consent form), reflecting the diverse ways consent can be captured and validated. The system parses the second consent format to extract its terms and conditions and compares them against the metadata of the available data clusters. It identifies and selects the second cluster, which corresponds to the second non-native data source and complies with the specific terms of the second consent. Throughout this process, the system ensures compliance and security by authenticating the user, verifying the validity of the consents, and applying access controls to restrict data retrieval to authorized clusters. The selected clusters are then aggregated, processed, or transformed as needed for the intended use, such as analysis or model training. Metadata documenting the consent details, the formats used, and the cluster selection process is recorded to provide an auditable trail, ensuring transparency and alignment with privacy regulations. By dynamically interpreting and applying consents in varying formats, the system facilitates secure and compliant retrieval of the second dataset.

At step 406, process 400 (e.g., using one or more components described above) receive a system request. For example, the system may receive a system request for training data (or for another purpose) for a first model, wherein the system request has a first request characteristic. For example, the system may receive a request for training data (or for another purpose) for a first model by processing a system-generated or user-initiated request that specifies a set of characteristics or parameters defining the data needed. This request, which includes a first request characteristic, is submitted through a designated interface or API that communicates with the system's data management and retrieval modules. The first request characteristic may define attributes such as the type of data required (e.g., text, image, or tabular data), the source of the data (native or non-native), the scope or time range of the data, or any constraints related to usage, sensitivity, or compliance. Upon receiving the request, the system parses the input to extract the first request characteristic and evaluates it against its data inventory, which includes metadata annotations for all available datasets and clusters. The system then determines which data subsets meet the specified characteristic and identifies any additional constraints, such as access permissions or approved-use authorizations, that must be respected. If the request pertains to sensitive or secured data, the system performs an authentication and authorization check to ensure that the requester has the necessary rights to access the requested data. Once the validation steps are complete, the system retrieves the relevant data or prepares it for the requested purpose, such as training the first model. This may involve preprocessing the data (e.g., normalization, augmentation, or filtering) to align it with the requirements of the model or the specified purpose. Throughout the process, the system ensures data security and compliance, using secure transfer protocols and maintaining an audit trail of the request and its fulfillment. By systematically handling requests based on specific characteristics, the system ensures that the right data is delivered efficiently and securely for the intended use.

At step 408, process 400 (e.g., using one or more components described above) activate a data retrieval workflow based on the system request. For example, the system may, in response to the system request, activate a data retrieval workflow. For example, in response to a system request, the system activates a data retrieval workflow by initiating a series of automated processes designed to identify, access, and prepare the requested data while adhering to security, compliance, and performance requirements. The workflow begins with the system parsing the request to extract key parameters, such as the type of data needed, the scope of the request, and any specified characteristics or constraints (e.g., data format, time range, or approved-use authorizations). Based on these parameters, the system determines the relevant datasets or clusters, referencing its metadata catalog to locate the data that matches the request. Next, the system performs an authentication and authorization check to verify that the requester has the appropriate permissions to access the specified data. If the request involves sensitive or secured data, the workflow integrates security protocols, such as token-based authentication, role-based access controls, or encryption keys, to ensure data protection. Once access is granted, the workflow dynamically generates and executes queries against the system's data storage layers, retrieving the required data subsets from the appropriate sources, such as native or non-native datasets. As the data is retrieved, the workflow applies any necessary preprocessing steps, including data cleaning, normalization, or transformation, to ensure the data is in the required format and ready for its intended purpose, such as training a model. If the request includes specific constraints, such as anonymization or aggregation, these are also applied during preprocessing. The system then securely delivers the processed data to the designated endpoint, such as a model training module or another downstream application, using secure transmission protocols (e.g., HTTPS or encrypted file transfers). Throughout the process, the workflow maintains an audit trail, logging key actions such as query execution, data retrieval, preprocessing steps, and data delivery. This ensures transparency and accountability while enabling the system to monitor performance and compliance with policies. By automating and securing the data retrieval workflow, the system ensures that requests are fulfilled efficiently, accurately, and in alignment with user and regulatory requirements.

In some embodiments, the data retrieval workflow may comprise accessing the native data from the first dataset, determining a data sufficiency of the native data, and, in response to determining that the native data is insufficient, accessing the non-native data from the second dataset, wherein accessing the non-native data comprises comparing the system request to a first data cluster characteristic corresponding to the first data cluster. For example, the data retrieval workflow executes by systematically accessing data from native and non-native datasets, assessing its sufficiency, and dynamically incorporating additional data as needed. The workflow begins by accessing native data from the first dataset, which contains data collected directly through the system's processes. This is achieved by querying the first dataset using parameters specified in the system request, such as data type, time range, or other characteristics. Once the native data is retrieved, the workflow evaluates its sufficiency by comparing the retrieved data against the requirements of the system request. This evaluation may include checking the volume, diversity, or completeness of the data relative to the task at hand, such as training a model or supporting a specific application. If the workflow determines that the native data is insufficient—either quantitatively or qualitatively—it proceeds to access non-native data from the second dataset. Accessing the non-native data involves comparing the parameters of the system request to the metadata of the second dataset's clusters. Specifically, the workflow identifies a first data cluster characteristic corresponding to the first data cluster, such as the type of data it contains, its approved-use authorizations, or its relevance to the system request. This ensures that only data aligning with the request's requirements and usage constraints is considered. After identifying the appropriate cluster(s), the workflow retrieves the relevant non-native data and integrates it with the native data. Before integration, the workflow may apply additional validation or preprocessing steps to ensure compatibility, security, and compliance with usage policies. For instance, the data might be anonymized, filtered, or transformed to match the format and quality standards of the native data. The combined dataset is then assessed for sufficiency once more and prepared for its intended purpose, such as feeding it into a machine learning model. Throughout this process, the workflow ensures secure access and data governance by enforcing authentication, encryption, and role-based permissions. An audit trail documents each step, including the determination of data sufficiency and the retrieval and integration of native and non-native data, ensuring transparency and regulatory compliance. By dynamically accessing and combining data from multiple sources based on sufficiency and request characteristics, the workflow ensures that the system can meet its objectives efficiently and securely.

In some embodiments, the system may compare the system request to the first data cluster characteristic corresponding to the first data cluster by determining the first approved-use authorization for the first data cluster based on the first data cluster characteristic, determining a requested use based on the system request, comparing the first approved-use authorization to the requested use, and determining to use the first data cluster based on comparing the first approved-use authorization to the requested use. For example, the system compares the system request to the first data cluster characteristic corresponding to the first data cluster by following a structured process to ensure alignment between the requested use and the cluster's approved-use authorization. Initially, the system examines the first data cluster characteristic, which includes metadata such as its origin, type, and approved-use authorization. This authorization specifies the purposes for which the data within the cluster can be accessed, such as analytics, research, or compliance-related activities. Next, the system interprets the system request to determine the requested use. This involves parsing the request to identify the purpose or application for which the data is needed, such as training a machine learning model or conducting a statistical analysis. The system then compares the first approved-use authorization of the data cluster to the requested use by evaluating whether the request falls within the scope of the authorization. For instance, if the authorization permits research-only use and the system request specifies a research activity, the uses align. If the system determines that the requested use is compatible with the first approved-use authorization, it proceeds to select the first data cluster for the retrieval process. Otherwise, the system excludes the cluster from consideration, ensuring that data is only accessed in accordance with its approved-use limitations. This comparison process ensures compliance with data governance policies and safeguards against unauthorized use. By dynamically evaluating the alignment between the system request and the data cluster's characteristics, the system ensures secure and appropriate use of the data.

In some embodiments, the system may compare the system request to the first data cluster characteristic corresponding to the first data cluster by determining a first approved data retention time for the first data cluster based on the first data cluster characteristic, determining a current time, comparing the first approved data retention time to the current time, and determining to use the first data cluster based on comparing the first approved data retention time to the current time. For example, the system compares the system request to the first data cluster characteristic corresponding to the first data cluster by evaluating the cluster's approved data retention time relative to the current time. First, the system examines the first data cluster's metadata, which includes a characteristic specifying the approved data retention time. This retention time defines the duration for which the data is authorized to be stored and accessed for specific purposes, such as analytics or compliance reporting. Next, the system determines the current time, using an internal or synchronized clock to ensure accuracy. It then compares the first approved data retention time to the current time to assess whether the data is still within its valid retention period. For example, if the data cluster's retention time expires on a specific date and the current time is beyond this date, the data is deemed no longer valid for use. Conversely, if the current time falls within the retention period, the data remains eligible for use. Based on this comparison, the system decides whether to include the first data cluster in the data retrieval process. If the retention period has not expired, the system determines that the first data cluster can be used for fulfilling the system request. If the retention period has expired, the system excludes the data cluster, ensuring compliance with data governance and regulatory requirements. By systematically evaluating the retention time, the system ensures that only data within its approved usage period is accessed, supporting secure and lawful data operations.

In some embodiments, the system may compare the system request to the first data cluster characteristic corresponding to the first data cluster by determining a first consent format for the first data cluster based on the first data cluster characteristic, determining a required consent format based on the system request, comparing the first consent format to the required consent format, and determining to use the first data cluster based on comparing the first consent format to the required consent format. For example, the system may compare the system request to the first data cluster characteristic corresponding to the first data cluster by evaluating the compatibility of the consent format associated with the cluster against the required consent format specified in the system request. First, the system examines the metadata of the first data cluster to determine its consent format. This format describes how consent was obtained or validated for the data in the cluster, such as a signed document, digital agreement, or token-based consent. Next, the system parses the system request to identify the required consent format for the requested operation. The required consent format specifies the type of user authorization or legal agreement necessary to access or use the data for the purpose defined in the request. For instance, the system may require explicit digital consent for high-risk operations or rely on implied consent for lower-risk tasks. The system then compares the first consent format of the data cluster to the required consent format from the system request. This comparison ensures that the consent format used to authorize the inclusion of the data in the cluster aligns with the conditions set by the system request. If the first consent format meets or exceeds the requirements of the system request, the system determines that the first data cluster is eligible for use. If the consent format does not meet the necessary criteria, the system excludes the data cluster from consideration, ensuring compliance with legal and ethical data governance standards. By verifying the compatibility of consent formats, the system ensures that only data clusters with appropriate consent are accessed, maintaining trust and compliance with privacy regulations and organizational policies.

In some embodiments, the system may compare the system request to the first data cluster characteristic corresponding to the first data cluster by determining a first data type for the first data cluster based on the first data cluster characteristic, determining a required type based on the system request, comparing the first data type to the required type, and determining to use the first data cluster based on comparing the first data type to the required type. For example, the system may compare the system request to the first data cluster characteristic corresponding to the first data cluster by evaluating the compatibility of the data type in the cluster with the type required by the system request. First, the system analyzes the metadata associated with the first data cluster to determine its data type. This data type describes the format or structure of the data contained in the cluster, such as text, numerical values, images, audio, or a specific schema (e.g., JSON or tabular data). Next, the system parses the system request to identify the required data type necessary to fulfill the request. This required type reflects the format or structure of data expected by the process or application specified in the request, such as a machine learning model needing numerical data or a natural language processing system requiring text data. The system then compares the first data type of the cluster to the required data type outlined in the system request. If the data type in the cluster matches or is compatible with the required type, the system determines that the first data cluster can be used to fulfill the request. For example, if the request requires tabular data for statistical analysis and the cluster contains appropriately formatted numerical data, the system confirms its suitability. Conversely, if the data type is incompatible—for instance, if the cluster contains image data but the request requires text—the system excludes the cluster from consideration. By performing this comparison, the system ensures that only data clusters containing the appropriate data type are used, supporting the accuracy, efficiency, and reliability of downstream processes. This approach also helps maintain data integrity and optimizes resource utilization by avoiding the inclusion of irrelevant or incompatible data.

In some embodiments, the system may compare the system request to the first data cluster characteristic corresponding to the first data cluster by determining, based on the first data cluster characteristic, a probability that first data cluster data in the first data cluster corresponds to the native data in the first dataset, determining a required probability based on the system request, comparing the probability to the required probability, and determining to use the first data cluster characteristic based on comparing the probability to the required probability. For example, the system may compare the system request to the first data cluster characteristic corresponding to the first data cluster by evaluating the likelihood that the data within the first data cluster aligns with the native data in the first dataset. Initially, the system examines the first data cluster's characteristic metadata, which may include attributes such as data source information, origin tracking, or similarity metrics. Using this metadata, the system determines a probability that the data in the first data cluster corresponds to or shares characteristics with the native data from the first dataset. This probability is typically calculated using statistical methods, similarity algorithms, or provenance analysis, assessing factors such as data schema alignment, content patterns, or source lineage. Next, the system interprets the system request to identify the required probability threshold necessary for selecting data clusters. This required probability reflects the level of confidence the system needs to ensure the first data cluster is sufficiently related to the native data for the intended purpose. For example, a high threshold may be required for processes demanding strict data alignment, such as compliance audits or sensitive analytics, while lower thresholds may suffice for exploratory tasks. The system then compares the calculated probability of alignment to the required probability. If the probability meets or exceeds the required threshold, the system determines that the first data cluster is appropriate for use in fulfilling the system request. Conversely, if the probability falls short of the required level, the system excludes the data cluster, ensuring that only data with a satisfactory degree of correspondence to the native data is selected. By performing this comparison, the system ensures that data clusters are chosen based on their relevance and alignment with the native dataset's characteristics, supporting accurate and reliable outcomes. This process also helps maintain data integrity, as it minimizes the risk of incorporating unrelated or incompatible data into the workflow.

In some embodiments, the system may compare the system request to the first data cluster characteristic corresponding to the first data cluster by determining, based on the first data cluster characteristic, an output effect on the first model, determining an excluded output effect based on the system request, comparing the output effect to the excluded output effect, and determining to use the first data cluster characteristic based on comparing the output effect to the excluded output effect. For example, the system may compare the system request to the first data cluster characteristic corresponding to the first data cluster by evaluating the impact of the data on the output of the first model and ensuring it aligns with the constraints defined in the system request. First, the system analyzes the first data cluster's characteristic metadata to determine its potential output effect on the first model. This output effect represents how the inclusion of data from the first cluster is expected to influence the model's predictions, behavior, or performance. The system may estimate this effect through prior analysis, simulation, or feature impact assessment, considering factors such as bias introduction, prediction accuracy, or changes to model interpretability. Next, the system interprets the system request to identify any excluded output effects. These exclusions specify undesirable impacts that the data must avoid, such as introducing bias, degrading model accuracy, violating compliance requirements, or skewing results in unintended ways. For example, the system request might exclude data clusters that are likely to introduce demographic bias or that significantly alter prediction confidence. The system then compares the determined output effect of the first data cluster to the excluded output effects specified in the request. If the output effect does not overlap with or contradict the excluded effects, the system determines that the first data cluster is suitable for use in fulfilling the request. Conversely, if the output effect aligns with any excluded effects, the system excludes the cluster to prevent adverse impacts on the model's outputs. By systematically evaluating the relationship between the data cluster's characteristics and the model's output, the system ensures that only data clusters with acceptable effects are utilized. This approach safeguards model integrity, compliance, and fairness, while optimizing the relevance and quality of the training or operational data.

In some embodiments, the system may determine the data sufficiency of the native data by determining an amount of the native data, determining, based on the system request, a required amount, and comparing the amount to the required amount. For example, the system determines the data sufficiency of the native data by evaluating whether the quantity of native data meets the requirements specified in the system request. First, the system calculates the amount of native data available in the first dataset. This calculation may involve counting the number of data entries, records, or points, or assessing the size of the dataset in terms of bytes or other relevant metrics, depending on the type of data (e.g., text, numerical, or multimedia). Next, the system interprets the system request to determine the required amount of data needed to fulfill the request. This requirement is typically defined based on the intended purpose, such as training a machine learning model, performing statistical analysis, or generating insights. For instance, the system request might specify a minimum number of data points, a target dataset size, or a threshold sufficient for achieving robust model performance or accurate results. The system then compares the determined amount of native data to the required amount. If the available data meets or exceeds the required threshold, the system determines that the native data is sufficient for the system request. Conversely, if the amount falls short of the required level, the system concludes that the native data is insufficient and may proceed to supplement the dataset with additional data, such as from non-native sources. This comparison process ensures that the system efficiently evaluates data sufficiency and dynamically adjusts its approach to meet the system request's needs. By quantifying and comparing data availability against specific requirements, the system maintains the integrity and relevance of the data for its intended application.

In some embodiments, the system determines the data sufficiency of the native data by determining a type of the native data, determining, based on the system request, a required type, and comparing the type to the required type. For example, the system may determine the data sufficiency of the native data by assessing whether the type of data in the native dataset aligns with the type required by the system request. First, the system examines the native data to determine its type, which could include the format, structure, or content classification of the data. Examples of data types include numerical, categorical, textual, image, audio, or specific schema-based formats such as JSON or tabular data. This determination is typically based on metadata associated with the dataset or an analysis of the data's content. Next, the system interprets the system request to identify the required data type necessary for fulfilling the request. This required type is derived from the intended application, such as training a specific model, performing an analysis, or supporting a business process. For example, a machine learning model designed for natural language processing may require textual data, while a computer vision application would need image data. The system then compares the determined type of the native data to the required type specified in the system request. If the type of the native data matches or is compatible with the required type, the system determines that the native data is sufficient for the request. However, if there is a mismatch—for instance, if the native data consists of numerical values while the request requires textual data—the system concludes that the native data is insufficient. This process ensures that the data provided for a specific purpose is appropriate and aligned with the operational or analytical requirements of the system request. By evaluating the type of native data against the required type, the system maintains data relevance, improves the quality of results, and minimizes inefficiencies or errors in downstream applications.

In some embodiments, the system may determine the data sufficiency of the native data by determining a freshness of the native data, determining, based on the system request, a required freshness, and comparing the freshness to the required freshness. The system determines the data sufficiency of the native data by evaluating its freshness and ensuring it meets the temporal requirements specified in the system request. First, the system determines the freshness of the native data by analyzing timestamps or other temporal metadata associated with the dataset. Freshness refers to how recently the data was collected or updated, with more recent data being considered fresher. For example, the system might calculate the age of the data by subtracting the timestamp of the latest data entry from the current date. Next, the system interprets the system request to identify the required freshness for the data. The required freshness specifies the acceptable age range of the data for fulfilling the request, based on the intended use case. For example, real-time analytics might require data collected within the past few hours or days, whereas a historical analysis may permit older data. The system then compares the determined freshness of the native data to the required freshness outlined in the request. If the data's freshness falls within the acceptable range, the system determines that the native data is sufficient to meet the request's requirements. Conversely, if the data is too old or stale relative to the specified threshold, the system concludes that the native data is insufficient. In such cases, the system may seek to augment the dataset with fresher data from other sources, if available. By incorporating freshness as a criterion for data sufficiency, the system ensures that the data used is timely and relevant for the task at hand. This process improves the accuracy and reliability of outputs, especially in applications where data recency significantly impacts performance or decision-making.

At step 410, process 400 (e.g., using one or more components described above) generate a response to the system request using the data retrieval workflow. For example, the system may generate the training data based on the data retrieval workflow. For example, the system generates training data based on the data retrieval workflow by processing and transforming the retrieved data into a structured format suitable for the target model or application. After completing the retrieval workflow, which collects data from both native and non-native datasets based on sufficiency and relevance to the system request, the system begins by consolidating the retrieved data into a unified dataset. This involves merging data from different sources and clusters while ensuring consistency, such as harmonizing formats, aligning schemas, and resolving discrepancies in data quality or structure. Next, the system applies preprocessing steps to prepare the data for training. These steps may include cleaning the data to remove noise or irrelevant information, normalizing values to standardize numerical ranges, and encoding categorical variables into a machine-readable format. The system may also perform data augmentation, such as generating synthetic examples or transforming existing data to increase diversity and robustness in the training dataset. Additionally, it may balance the dataset by addressing issues like class imbalance to ensure equitable representation of various data categories. Once preprocessing is complete, the system evaluates the dataset against the specific requirements of the model. For instance, if the model requires labeled data, the system ensures proper annotation by leveraging existing labels or generating new ones through manual or automated methods, such as natural language processing or image recognition techniques. The system also partitions the dataset into training, validation, and testing subsets, following best practices to prevent overfitting and ensure reliable model evaluation. During the entire process, the system adheres to security and compliance standards, such as anonymizing sensitive data, encrypting data at rest and in transit, and applying access controls. Metadata about the training data, including its provenance, preprocessing steps, and any transformations applied, is documented to maintain traceability and support reproducibility in model development. By executing these steps within the framework of the data retrieval workflow, the system ensures that the generated training data is comprehensive, high-quality, and aligned with the model's requirements, enabling effective training and robust performance in downstream applications.

In some embodiments, the system may train the first model based on the training data and generate for display, on a user interface, a first recommendation based on a first output from the first model. For example, the system trains the first model using the prepared training data and utilizes the trained model to generate a recommendation for display on a user interface. First, the system ingests the training data, ensuring it is properly formatted and aligned with the model's requirements. The training process involves feeding the data into the model, which iteratively adjusts its internal parameters to minimize prediction errors or optimize a defined objective function. Depending on the model type, this process may include supervised learning, where labeled data guides the learning, or unsupervised learning, where the model identifies patterns or clusters without predefined labels. The system monitors the training process to prevent issues such as overfitting or underfitting and validates the model's performance using a separate validation dataset. Once the model is successfully trained and achieves acceptable performance metrics, the system applies it to generate predictions or outputs based on input data. In this case, the system uses the first model to produce a first output tailored to the requirements of the task or user request. The first output could be a decision, ranking, prediction, or another result relevant to the system's objective. The system then processes the first output to create a first recommendation, transforming the raw output into a user-friendly format or actionable insight. For example, if the model predicts a customer's likelihood to purchase a product, the recommendation might suggest a targeted marketing strategy. This recommendation is prepared for visualization and displayed on a user interface, using charts, text, or interactive elements to ensure clarity and usability for the end-user. Throughout this process, the system ensures that the data, model, and output comply with security and privacy guidelines, and it logs the operations for traceability and transparency. By training the first model on high-quality data and presenting the resulting recommendation effectively, the system enables users to make informed decisions based on the model's insights.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for cataloging secured data in encrypted clusters based on received authorizations.
2. The method of the preceding embodiment, further comprising: retrieving a first dataset, wherein the first dataset comprises native data; retrieving a second dataset, wherein the second dataset comprises non-native data, wherein the second dataset has a first data cluster corresponding to a first approved-use authorization applied to a first non-native data source used to populate the first data cluster, and wherein the second dataset has a second data cluster corresponding to a second approved-use authorization applied to a second non-native data source used to populate the first data cluster; receiving a system request for training data for a first model, wherein the system request has a first request characteristic; in response to the system request, activating a data retrieval workflow, wherein the data retrieval workflow: accesses the native data from the first dataset; determines a data sufficiency of the native data; and in response to determining that the native data is insufficient, accesses the non-native data from the second dataset, wherein accessing the non-native data comprises comparing the system request to a first data cluster characteristic corresponding to the first data cluster; and generating the training data based on the data retrieval workflow.
3. The method of any one of the preceding embodiments, wherein retrieving the second dataset comprises: receiving a first user authorization to aggregate data from the first non-native data source; receiving a second user authorization to aggregate data from the second non-native data source; in response to the first user authorization, populating the second dataset based on the first non-native data source; and in response to the second user authorization, populating the second dataset based on the second non-native data source.
4. The method of any one of the preceding embodiments, wherein retrieving the second dataset comprises: receiving, from a first user, a first approved-use for the first non-native data source; selecting the first data cluster, from a plurality of data clusters, based on the first approved-use; receiving, from the first user, a second approved-use for the second non-native data source; and selecting the second data cluster, from the plurality of data clusters, based on the second approved-use.
5. The method of any one of the preceding embodiments, wherein retrieving the second dataset comprises: receiving, from a first user, first consent in a first consent format for the first non-native data source; selecting the first data cluster, from a plurality of data clusters, based on the first consent format; receiving, from the first user, second consent in a second consent format for the second non-native data source; and selecting the second data cluster, from the plurality of data clusters, based on the second consent format.
6. The method of any one of the preceding embodiments, wherein comparing the system request to the first data cluster characteristic corresponding to the first data cluster further comprises: determining the first approved-use authorization for the first data cluster based on the first data cluster characteristic; determining a requested use based on the system request; comparing the first approved-use authorization to the requested use; and determining to use the first data cluster based on comparing the first approved-use authorization to the requested use.
7. The method of any one of the preceding embodiments, wherein comparing the system request to the first data cluster characteristic corresponding to the first data cluster further comprises: determining a first approved data retention time for the first data cluster based on the first data cluster characteristic; determining a current time; comparing the first approved data retention time to the current time; and determining to use the first data cluster based on comparing the first approved data retention time to the current time.
8. The method of any one of the preceding embodiments, wherein comparing the system request to the first data cluster characteristic corresponding to the first data cluster further comprises: determining a first consent format for the first data cluster based on the first data cluster characteristic; determining a required consent format based on the system request; comparing the first consent format to the required consent format; and determining to use the first data cluster based on comparing the first consent format to the required consent format.
9. The method of any one of the preceding embodiments, wherein comparing the system request to the first data cluster characteristic corresponding to the first data cluster further comprises: determining a first data type for the first data cluster based on the first data cluster characteristic; determining a required type based on the system request; comparing the first data type to the required type; and determining to use the first data cluster based on comparing the first data type to the required type.
10. The method of any one of the preceding embodiments, wherein comparing the system request to the first data cluster characteristic corresponding to the first data cluster further comprises: determining, based on the first data cluster characteristic, a probability that first data cluster data in the first data cluster corresponds to the native data in the first dataset; determining a required probability based on the system request; comparing the probability to the required probability; and determining to use the first data cluster characteristic based on comparing the probability to the required probability.
11. The method of any one of the preceding embodiments, wherein comparing the system request to the first data cluster characteristic corresponding to the first data cluster further comprises: determining, based on the first data cluster characteristic, an output effect on the first model; determining an excluded output effect based on the system request; comparing the output effect to the excluded output effect; and determining to use the first data cluster characteristic based on comparing the output effect to the excluded output effect.
12. The method of any one of the preceding embodiments, wherein determining the data sufficiency of the native data further comprises: determining an amount of the native data; determining, based on the system request, a required amount; and comparing the amount to the required amount.
13. The method of any one of the preceding embodiments, wherein determining the data sufficiency of the native data further comprises: determining a type of the native data; determining, based on the system request, a required type; and comparing the type to the required type.
14. The method of any one of the preceding embodiments, wherein determining the data sufficiency of the native data further comprises: determining a freshness of the native data; determining, based on the system request, a required freshness; and comparing the freshness to the required freshness.
15. The method of any one of the preceding embodiments, further comprising: training the first model based on the training data; and generating for display, on a user interface, a first recommendation based on a first output from the first model.
16. One or more non-transitory, computer-readable mediums storing instructions that, when executed by a data processing apparatus, cause the data processing apparatus to perform operations comprising those of any of embodiments 1-15.
17. A system comprising one or more processors; and memory storing instructions that, when executed by the processors, cause the processors to effectuate operations comprising those of any of embodiments 1-15.
18. A system comprising means for performing any of embodiments 1-15.

What is claimed is:

1. A system for securely cataloging data in data sparse environments using encrypted clusters based on received security authorizations specific to an encrypted clustering process, the system comprising:
one or more processors; and
one or more non-transitory, computer-readable mediums, comprising instructions that, when executed by the one or more processors, cause operations comprising:
receiving a user request to generate a first recommendation, wherein the first recommendation is based on non-public and secured data;
retrieving a first dataset, wherein the first dataset comprises native data, and wherein the native data comprises secured data for a first user received via a native data collection process;
retrieving a second dataset, wherein the second dataset comprises non-native data collected via a non-native data collection process, wherein the second dataset has a first data cluster corresponding to a first approved-use authorization applied to a first non-native data source used to populate the first data cluster, and wherein the second dataset has a second data cluster corresponding to a second approved-use authorization applied to a second non-native data source used to populate the first data cluster;
generating a system request for training data for a first model, wherein the system request has a first request characteristic;
in response to the system request, activating a data retrieval workflow, wherein the data retrieval workflow:
accesses the native data from the first dataset;
determines a data sufficiency of the native data; and
in response to determining that the native data is insufficient, accesses the non-native data from the second dataset, wherein accessing the non-native data comprises comparing the system request to a first data cluster characteristic corresponding to the first data cluster; and
generating the training data based on the data retrieval workflow;
training the first model based on the training data; and
generating for display, on a user interface, the first recommendation based on a first output from the first model.

2. A method for cataloging secured data in encrypted clusters based on received authorizations, the method comprising:
retrieving a first dataset, wherein the first dataset comprises native data;
retrieving a second dataset, wherein the second dataset comprises non-native data, wherein the second dataset has a first data cluster corresponding to a first approved-use authorization applied to a first non-native data source used to populate the first data cluster, and wherein the second dataset has a second data cluster corresponding to a second approved-use authorization applied to a second non-native data source used to populate the first data cluster;
receiving a system request for training data for a first model, wherein the system request has a first request characteristic;
in response to the system request, activating a data retrieval workflow, wherein the data retrieval workflow:
accesses the native data from the first dataset;
determines a data sufficiency of the native data; and
in response to determining that the native data is insufficient, accesses the non-native data from the second dataset, wherein accessing the non-native data comprises comparing the system request to a first data cluster characteristic corresponding to the first data cluster; and
generating the training data based on the data retrieval workflow.

3. The method of claim 2, wherein retrieving the second dataset comprises:
receiving a first user authorization to aggregate data from the first non-native data source;
receiving a second user authorization to aggregate data from the second non-native data source;
in response to the first user authorization, populating the second dataset based on the first non-native data source; and
in response to the second user authorization, populating the second dataset based on the second non-native data source.

4. The method of claim 2, wherein retrieving the second dataset comprises:
receiving, from a first user, a first approved-use for the first non-native data source;
selecting the first data cluster, from a plurality of data clusters, based on the first approved-use;
receiving, from the first user, a second approved-use for the second non-native data source; and
selecting the second data cluster, from the plurality of data clusters, based on the second approved-use.

5. The method of claim 2, wherein retrieving the second dataset comprises:
receiving, from a first user, first consent in a first consent format for the first non-native data source;
selecting the first data cluster, from a plurality of data clusters, based on the first consent format;
receiving, from the first user, second consent in a second consent format for the second non-native data source; and
selecting the second data cluster, from the plurality of data clusters, based on the second consent format.

6. The method of claim 2, wherein comparing the system request to the first data cluster characteristic corresponding to the first data cluster further comprises:
determining the first approved-use authorization for the first data cluster based on the first data cluster characteristic;
determining a requested use based on the system request;
comparing the first approved-use authorization to the requested use; and
determining to use the first data cluster based on comparing the first approved-use authorization to the requested use.

7. The method of claim 2, wherein comparing the system request to the first data cluster characteristic corresponding to the first data cluster further comprises:
determining a first approved data retention time for the first data cluster based on the first data cluster characteristic;
determining a current time;
comparing the first approved data retention time to the current time; and
determining to use the first data cluster based on comparing the first approved data retention time to the current time.

8. The method of claim 2, wherein comparing the system request to the first data cluster characteristic corresponding to the first data cluster further comprises:
determining a first consent format for the first data cluster based on the first data cluster characteristic;
determining a required consent format based on the system request;
comparing the first consent format to the required consent format; and
determining to use the first data cluster based on comparing the first consent format to the required consent format.

9. The method of claim 2, wherein comparing the system request to the first data cluster characteristic corresponding to the first data cluster further comprises:
determining a first data type for the first data cluster based on the first data cluster characteristic;
determining a required type based on the system request;
comparing the first data type to the required type; and
determining to use the first data cluster based on comparing the first data type to the required type.

10. The method of claim 2, wherein comparing the system request to the first data cluster characteristic corresponding to the first data cluster further comprises:
determining, based on the first data cluster characteristic, a probability that first data cluster data in the first data cluster corresponds to the native data in the first dataset;
determining a required probability based on the system request;
comparing the probability to the required probability; and
determining to use the first data cluster characteristic based on comparing the probability to the required probability.

11. The method of claim 2, wherein comparing the system request to the first data cluster characteristic corresponding to the first data cluster further comprises:
determining, based on the first data cluster characteristic, an output effect on the first model;
determining an excluded output effect based on the system request;
comparing the output effect to the excluded output effect; and
determining to use the first data cluster characteristic based on comparing the output effect to the excluded output effect.

12. The method of claim 2, wherein determining the data sufficiency of the native data further comprises:
determining an amount of the native data;
determining, based on the system request, a required amount; and
comparing the amount to the required amount.

13. The method of claim 2, wherein determining the data sufficiency of the native data further comprises:
determining a type of the native data;
determining, based on the system request, a required type; and
comparing the type to the required type.

14. The method of claim 2, wherein determining the data sufficiency of the native data further comprises:
determining a freshness of the native data;
determining, based on the system request, a required freshness; and
comparing the freshness to the required freshness.

15. The method of claim 2, further comprising:
training the first model based on the training data; and
generating for display, on a user interface, a first recommendation based on a first output from the first model.

16. One or more non-transitory, computer-readable mediums, comprising instructions that, when executed by one or more processors, cause operations comprising:
clustering data on a user into a first dataset and a second dataset, wherein the first dataset comprises native data, wherein the second dataset comprises non-native data, wherein the second dataset has a first data cluster corresponding to a first approved-use authorization applied to a first non-native data source used to populate the first data cluster, and wherein the second dataset has a second data cluster corresponding to a second approved-use authorization applied to a second non-native data source used to populate the first data cluster;
activating a data retrieval workflow in response to receiving a system request for training data for a first model, wherein the system request has a first request characteristic, and wherein the data retrieval workflow:
accesses the native data from the first dataset;
determines a data sufficiency of the native data;
in response to determining that the native data is insufficient, accesses the non-native data from the second dataset, wherein accessing the non-native data comprises comparing the system request to a first data cluster characteristic corresponding to the first data cluster; and
generating the training data based on the data retrieval workflow.

17. The one or more non-transitory, computer-readable mediums of claim 16, wherein retrieving the second dataset comprises:
receiving a first user authorization to aggregate data from the first non-native data source;
receiving a second user authorization to aggregate data from the second non-native data source;
in response to the first user authorization, populating the second dataset based on the first non-native data source; and
in response to the second user authorization, populating the second dataset based on the second non-native data source.

18. The one or more non-transitory, computer-readable mediums of claim 16, wherein retrieving the second dataset comprises:
receiving, from a first user, a first approved-use for the first non-native data source;
selecting the first data cluster, from a plurality of data clusters, based on the first approved-use;
receiving, from the first user, a second approved-use for the second non-native data source; and
selecting the second data cluster, from the plurality of data clusters, based on the second approved-use.

19. The one or more non-transitory, computer-readable mediums of claim 16, wherein retrieving the second dataset comprises:
receiving, from a first user, first consent in a first consent format for the first non-native data source;
selecting the first data cluster, from a plurality of data clusters, based on the first consent format;
receiving, from the first user, second consent in a second consent format for the second non-native data source; and
selecting the second data cluster, from the plurality of data clusters, based on the second consent format.

20. The one or more non-transitory, computer-readable mediums of claim 16, wherein comparing the system request to the first data cluster characteristic corresponding to the first data cluster further comprises:
determining, based on the first data cluster characteristic, an output effect on the first model;
determining an excluded output effect based on the system request;
comparing the output effect to the excluded output effect; and
determining to use the first data cluster characteristic based on comparing the output effect to the excluded output effect.
